(19) United States
(12) Patent Application Publication
(10) Pub. No.: US 2013/0148556 A1
(43) Pub. Date: Jun. 13, 2013

(54) System And Method For Access Point Power Save

(71) Applicants: Sathya Manickam, Chennai (IN); Vadivel Pitchaimani, Chennai (IN)

(72) Inventors: Sathya Manickam, Chennai (IN); Vadivel Pitchaimani, Chennai (IN)

(73) Assignee: Qualcomm Atheros, Inc., San Jose, CA (US)

(21) Appl. No.: 13/313,924

(22) Filed: Dec. 7, 2011

(51) Int. Cl. H04W 52/02; G08C 17/00; H04B 7/24

(52) U.S. Cl. 370/311; 455/522

(57) ABSTRACT

A power-save mode for a wireless access point is provided. The wireless access point can determine if other wireless stations are associated with the wireless access point. If there are no associations, then the wireless access point may enter a power-save mode. Associations may be determined by recent associations with the wireless access point or by media access control address activity. In the power-save mode, power may be reduced to at least one area of the wireless access point. In the power-save mode, the wireless access point may stop sending beacon signals. If the wireless access point receives a trigger signal, the wireless access point may leave the power-save mode.

### TECHNICAL FIELD

The present specification describes an apparatus and method that generally relates to saving power in a communication system and specifically to saving power in wireless LANs.

### BACKGROUND

Access points (APs) are important wireless devices in WLAN technology. Wireless devices can transfer data via access points using wireless technology. Typically, APs operate such that they may be always on and active even if there are no active wireless stations associated with them. Consider the situation in a home environment where a user connects a wireless station with an AP and uses the connection for browsing. If the user subsequently travels from home, e.g. to the office, the user may return home from his work after 6-8 hours. The home-based AP may still be in on state and actively operating with the AP beacon transmitting every configured interval (a typical value is transmitting every 100 ms). The AP has consumed considerable power and has not provided useful communication to any wireless stations. Thus, it would be beneficial if access points had a mode to reduce power consumption under these conditions.

### SUMMARY

A method for saving power in a wireless access point is disclosed. The wireless access point can determine if there are any active associations related to the access point. If there are no active associations, the access point can enter a power-save mode wherein areas of the access point may operate with a reduced power. Active associations may be determined by examining a list of associated access points. Active associations may also be determined by examining a list of MAC addresses that may have been active with the access point. The access point can leave the power-save mode when a triggering signal is received. In one embodiment, a triggering signal can be a probe request.

A wireless access point that supports an AP power-save mode is disclosed. The wireless access point may include an association table, an activity monitor, and a power configurator. The activity monitor can monitor the association table and determine if there are no wireless stations associated with the AP. If there are no associated stations, then the activity monitor can signal the power configurator to reduce power to at least one area of the wireless access point. If there are no associated stations, then the power configurator can signal a controller included in the wireless access point to stop sending beacon signals.

The wireless access point may include a media access control (MAC) address table and a MAC address ager. The MAC address ager may remove MAC addresses from the MAC address table if no activity related to a particular MAC address occurs after a predetermined amount of time. The wireless access point may include a MAC address table monitor. If the MAC address table is empty, then the MAC address table monitor may signal the power configurator. In response, the power configurator can reduce power to at least one portion of the wireless access point. If the MAC address table is empty, then the power configurator can signal the controller included in the wireless access point to stop sending beacon signals.

### BRIEF DESCRIPTION OF THE DRAWINGS

FIG. 1 illustrates beacon and probe signaling between an access point and a wireless station according to the prior art.

FIG. 2 is a flowchart of method steps implementing an AP power-save mode.

FIG. 3 illustrates wireless activity of a wireless system according to one embodiment of the specification.

FIG. 4 is a block diagram of one embodiment of a wireless station.

The components in the figures are not necessarily to scale, emphasis instead being placed upon illustrating the principles of the present specification. In the figures, like reference numerals designate corresponding parts throughout the different views.

### DETAILED DESCRIPTION

The present specification discloses an access point (AP) power-save mode that may be used when there are no active wireless stations serviced by the AP.

### Definitions

Stations, wireless stations, mobile stations, wireless devices, mobile devices and network cards (NIC) are equivalent functions/devices capable of wireless communications with an access point.

Access points (APs) may be wireless stations used in a wireless local area network (WLAN) and may support IEEE 802.11 or equivalent communications. An AP may also include a router and may be referenced as AP/router. Other wireless stations may associate with an AP. APs may provide access to networks and/or computers beyond those that may be associated with the AP by routing traffic from associated wireless stations to other devices beyond the WLAN.

Soft-AP is a software application which may enable a WLAN equipped wireless client such as a laptop or mobile phone to act as an AP or an AP/router combination.

An active AP refers to an AP that is associated with at least one wireless station or has at least one current media access control (MAC) address entry for at least one wireless device.

Wireless stations may associate (register) with an AP to gain access to a network. Association enables wireless stations to transmit and receive data to and from the AP. Association may occur on wireless infrastructure networks, not in ad hoc (peer-peer) networks, and may be logically analogous to connecting into a wired network. Typically, a wireless station may only associate with one AP at a time.

Association occurs after authentication. Authentication establishes an identity of a wireless station but does not allow data transfer. An authenticated wireless station may, for example, join a basic service set (BSS) of an AP, but data may not be transferred until the wireless station has associated with the AP.

To associate to an AP, the wireless station may send an association request. Next, the AP may process the Association Request. The AP may accept the association request in which case the AP may grant the association and may transmit and receive frames (data) to/from the wireless station. The AP may make a note of the associated wireless station to allow future data transfers without having to associate prior to every transfer.

To prolong battery life of wireless stations, the IEEE 802.11 standard defines an optional “power save mode,” which is available on many IEEE 802.11 compliant wireless devices. Typically, end users may simply turn the power save mode on or off via a configuration tool. The wireless station may consume relatively less power while in a power save mode by reducing power to unused circuits. Typically, a timing circuit is left in a powered state. The timing circuit enables the wireless station wake up periodically (return to a normal power state) to receive beacon transmissions from the access point while otherwise operate at a reduced power level. The beacons may identify whether power save mode stations may have data packets buffered at the access point and waiting for delivery. When a wireless station in a power save mode wakes up and learns from the beacons that there are packets waiting, the wireless station can communicate with the access point to retrieve the data. After that, the wireless station may return to the power save mode until the next beacon transmission.

There is no reciprocal, standardized power save mode available for APs. Per current IEEE 802.11 standards, beacons are transmitted by the AP when the AP is switched on. Beacons are typically sent periodically every 100 ms. Therefore, in 1 minute, the number of beacons transmitted may be 600. There may be a signification amount of energy expended if there are no wireless stations actively communicating with the AP.

For example, if an AP is switched on and there no associated wireless station, the beacons may continue to be transmitted and the AP may operate at full power. This behavior is common in 2.4 and 5 GHz. In this scenario, access points may consume a certain amount of power to transmit beacons to no wireless stations.

Consider when a mobile device such as a mobile phone may act as an AP. This may be the case when a mobile device may run a Soft-AP program and the mobile device may perform duties of an AP. The mobile device may transfer data for an amount of time and may thereafter become idle because, for example, there may be no associated wireless stations within range of the Soft-AP. The Soft-AP may still transmit beacons and consume power until the user turns the Soft-AP off Since mobile devices are often battery powered, battery life may be adversely affected.

In such a scenario, i.e. where the user enables the Soft-AP and subsequently does not use the AP functionality, saving power may be of particular interest to extend battery life.

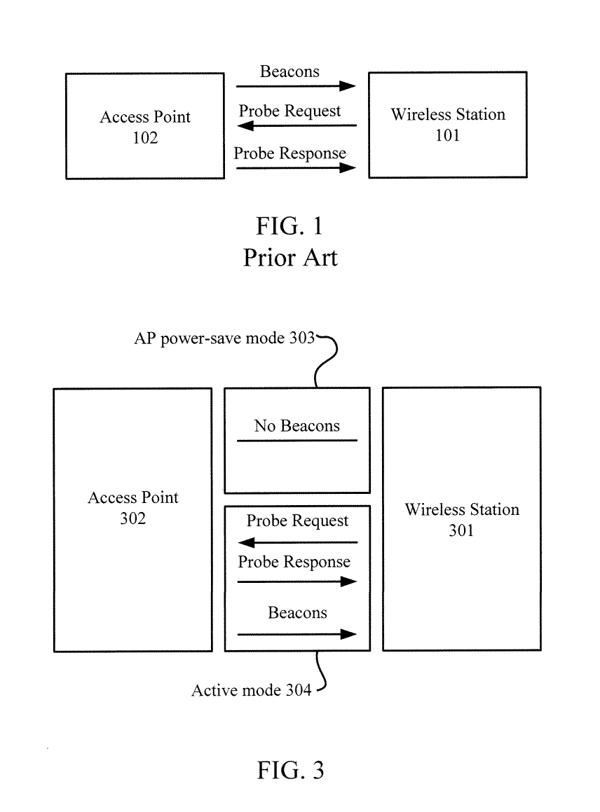

FIG. 1 illustrates beacon and probe signaling between an access point 102 and a wireless station 101 according to the prior art. Per FIG. 1, access point 102 may periodically transmit beacons, which may be received by wireless station 101. A beacon signal may be a periodic transmission that may include information such as an SSID (service set identifier) and capability information such as supported transmission rates. Wireless station 101 may transmit a probe request that may be received by the access point 102. A probe request may be sent to retrieve information regarding, among other things, SSID and capability information. In turn, the access point 102 may transmit a probe response to the wireless station 101. A probe response may be similar to a beacon and contain SSID and capability information.

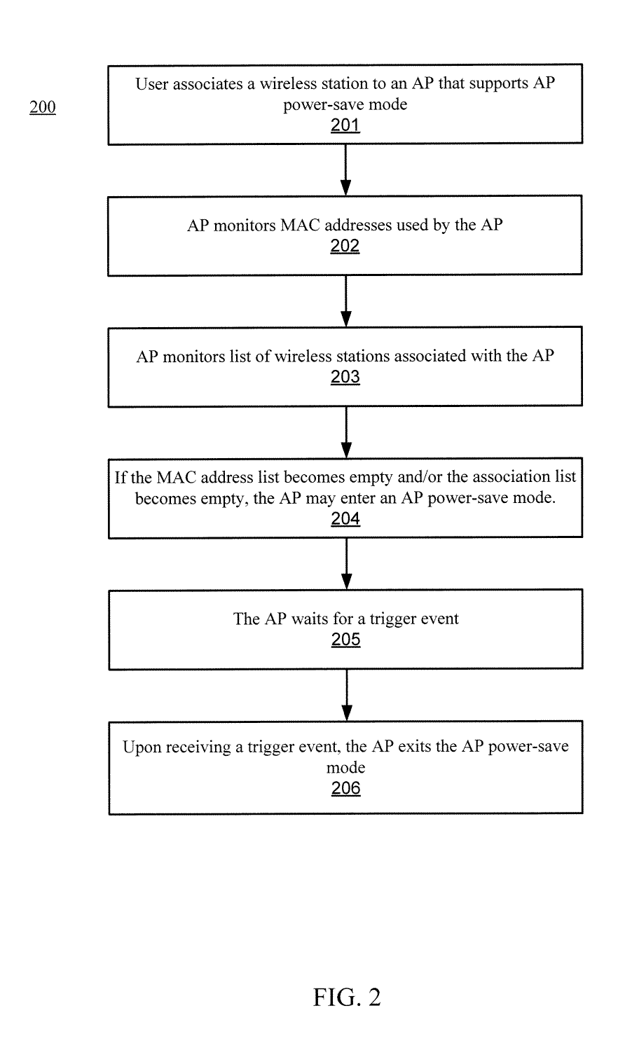

In one embodiment, access points may save power when they are not providing service to wireless stations. FIG. 2 is a flowchart of method steps 200 implementing an AP power-save mode.

In step 201, a user associates a wireless station to an AP that supports AP power-save mode. The user may use this association for accessing the Internet or transferring data through the AP.
In step 202, the AP monitors MAC addresses used by the AP. The AP may maintain a list of MAC addresses that may have been recently used. Oftentimes a MAC address may correspond with an IP (internet protocol) address. The AP may use this correspondence to route data for associated wireless stations to a particular IP address. The presence of a MAC address on this MAC address list may indicate an active or recent connection between that particular MAC address and the AP. Since the MAC address list in the AP may have a limited amount of room, the AP may remove MAC addresses from the list if the AP has not used them within a predetermined amount of time. This process is called MAC address aging herein.
In step 203, the AP monitors list of wireless stations associated with the AP. As wireless stations associate through the AP, the AP may add these wireless stations to an association list. The association list effectively enumerates wireless stations that may be associated and actively transferring data to and from the AP or accessing the Internet using the AP.
In step 204, if the MAC address list becomes empty and/or the association list becomes empty, then the AP may enter an AP power-save mode. An empty MAC address list or an empty association list may indicate that there are no active associations (i.e. no active wireless stations) with the AP. In this mode, the AP may stop transmitting beacons and reduce power consumption. In some embodiments, the AP may reduce power to one or more areas of the AP.
In step 205, the AP waits for a trigger event. The trigger event can be used to indicate that the AP should leave the AP power-save mode and return to normal operation. In one embodiment, a trigger event can be receiving a probe request or receiving an active scan request.
In step 206, upon receiving a trigger event, the AP exits the AP power-save mode. The AP may resume transmitting beacons and/or probe responses.

FIG. 3 illustrates wireless activity of a wireless system according to one embodiment of the specification. The wireless system may include an access point 302 and a wireless station 301. If the wireless station 301 is out of wireless range of the access point 302, or if the wireless station 301 is powered down, then the wireless station may not be included in the association list or the MAC address list maintained by the access point 301. If so, then the access point 302 may enter an AP power-save mode 303 and not transmit beacons. Also, one or more areas of the access point 302 may be placed in a reduced power mode.

Alternatively, wireless station 301 may be powered on and appear on the association list or the MAC address list maintained by the access point 302. In response, access point 302 may enter an active mode 304, and begin transmitting beacons. Also, in response to receiving a probe request, the access point 302 may transmit a probe response to the wireless station 303.

In some localities, the described AP power-save mode may only be implemented for access points and wireless stations functioning in the 2.4 GHz ISM (Industrial, Scientific and Medial) band. Operation in the 5 GHz frequency band may be more restrictive because of regulatory rules in some jurisdictions. For example, some countries may restrict the transmission of probe requests in portions of the 5 GHz band.

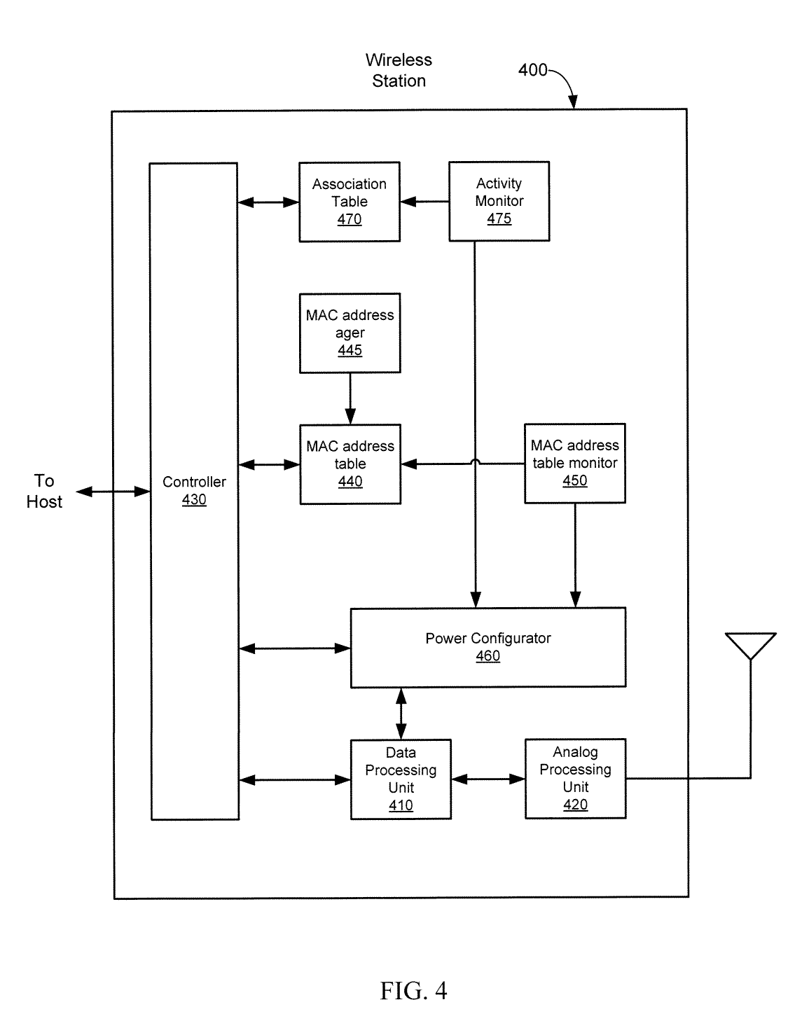

FIG. 4 is a block diagram of one embodiment of a wireless station 400. The wireless station 400 may be configured to operate as an access point and may include one or more data processing units 410 and one or more analog processing units 420 that may be configured to transmit and receive wireless data to other wireless devices that may be associated with the wireless station 400. In one embodiment, the data processing unit 410 may perform digital signal processing on data to be transmitted and the analog processing unit 420 may convert digital data from the data processing unit 410 into analog data and may modulate the analog data with a carrier frequency and transmit the resulting signal. For simplicity, only one data processing unit 410 and one analog processing unit 420 is shown in wireless station 400. Other embodiments may include multiple data processing units 410 and analog processing units 420 as may be the case for a multiple-input multiple-output (MIMO) system.

The wireless station 400 may also include a controller 430. The controller 430 may be coupled to a host (not shown). The controller 430 may receive data to be transmitted from the host. The controller 430 may, among other things, process data from the host prior to passing the data to the data processing unit 410 (wireless data transmission). The controller 430 may also provide data to the host that has been received by the data processing unit 410 and the analog processing unit 420 (wireless data reception). Often, data for transmission may need a MAC address in order to form a data packet for transmission to a connected wireless device. The MAC address may be stored in a MAC address table 440. If data is not transmitted or received from a MAC address after a predetermined amount of time has elapsed, a MAC address ager 445 may remove the MAC address from the MAC address table 440.

A MAC address table monitor 450 may monitor the MAC address table 440. The MAC address table monitor 450 may signal the power configurator 460 that the MAC address table 440 may not include any MAC addresses. The power configurator 460 may signal the controller 430 to stop sending beacon signals. In response, the power configurator 460 may reduce to power to one or more areas of the wireless station 400. In one embodiment, the power configurator 460 may reduce power to the data processing unit 410 and/or the analog processing unit 420.

The wireless station 400 may also include an association table 470. In one embodiment, the association table 470 may include a list of access points actively associated with the wireless station 400. By way of example, wireless station 400 may act as an access point and may be associated with another wireless device, thereby allowing wireless station 400 to receive data from or transmit data to the other wireless device. The other wireless device may be noted in the association table 470. If the other wireless device is no longer being serviced by the wireless station 400 (e.g. the other wireless device may power down or move out of range of the wireless station 400), then the other wireless device may be removed from the association table 470 by the controller 430. An activity monitor 475 may monitor the association table 470. If the association table 470 does not include any wireless devices, then the activity monitor 475 may signal the power configurator 460. In response, the power configurator 460 may signal the controller 430 to stop sending beacons. The power configurator 460 may also reduce power to at least one portion of the wireless station 400.

While various embodiments of the Specification have been described, it will be apparent to those of ordinary skill in the art that many more embodiments and implementations are possible that are within the scope of this Specification. For example, any combination of any of the systems or methods described in this disclosure is possible.

What is claimed is:

1. A method for saving power in a wireless access point (AP), the method comprising:
determining that there are no active connections related to the access point;
configuring the access point to be in a power-save mode wherein at least one area of the access point operates in a reduced power state; and
remaining in the power-save mode until the access point receives a triggering signal.

2. The method of claim 1, wherein the active connections are determined by examining a list of previously associated wireless stations and determining that the list is empty.

3. The method of claim 2, wherein the active connections are further determined by examining a list of media access control (MAC) addresses and determining that there are no MAC addresses on the MAC address list.

4. The method of claim 1, wherein the access point does not transmit beacons in the power-save mode.

5. The method of claim 3, the method further comprising:
receiving the triggering signal; and
configuring the access point to leave the power-save mode in response to receiving the triggering signal.

6. The method in claim 5, wherein the trigging signal is a probe request from a wireless station.

7. An access point comprising:
an association table configured to include a list of wireless stations that are associated with the access point;
an activity monitor configured to monitor the association table; and
a power configurator configured to reduce power to at least one area of the access point when the activity monitor determines that there are no wireless stations currently associated with the access point.

8. The access point of claim 7, wherein the power configurator is further configured to stop the access point from transmitting beacon signals when the activity monitor determines that there are no wireless stations currently associated with the access point.

9. The access point of claim 7, further comprising:
a media access control (MAC) address table configured to include MAC addresses corresponding to wireless stations that have been associated with the access point;
a MAC address ager configured to remove MAC addresses from the MAC address table after a predetermined time period has passed if no activity has been determined from a particular MAC address;
a MAC address table monitor configured to determine the number of the MAC addresses included in the MAC address table;
wherein the power configurator is further configured to reduce power to at least one area of the access point when the MAC address table monitor determines that the MAC address table is empty.

10. The access point of claim 9, wherein the power configurator is further configured to stop the access point from transmitting beacon signals when MAC address table monitor determines that the MAC address table is empty.

11. The access point of claim 10, wherein the wireless station is further configured to receive a trigger signal.

12. The access point of claim 11, wherein the trigger signal is a probe request.

13. The access point of claim 11, wherein the power configurator is further configured to restore power to at least one area of the access point.

14. The access point of claim 13, wherein the power configurator allows the access point to transmit beacon signals.

15. A method for saving power in an access point, the method comprising:
allowing at least one wireless station to connect to the access point;
waiting for the connections to the access point to become inactive;
entering a power-save mode wherein the access point stops transmitting beacons; and
leaving the power-save mode when the access point receives a trigger signal.

16. The method of claim 15, wherein the trigger signal is a probe request.

17. The method of claim 15, wherein the power-save mode also comprises reducing the power to at least one area of the access point.
